(19) United States
(12) Patent Application Publication
(10) Pub. No.: US 2008/0031598 A1
(43) Pub. Date: Feb. 7, 2008

(54) Graphic Recording Apparatus

(76) Inventors: YASUNORI OHARA, Yokohama (JP); Kouji Nosato, Yokohama (JP); Hajime Takasugi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/696,755

(22) Filed: Apr. 5, 2007

(30) Foreign Application Priority Data
Aug. 31, 2005 (JP) JP 2006-234893

(51) Int. Cl. H04N 7/26

(52) U.S. Cl. 386/124

(57) ABSTRACT

A graphic recording apparatus would become a costly device if requirement needs to be satisfied in both the points of high image quality and long-hour recording. A solution proposed here is to perform a simple data conversion to suppress high-frequency component by masking lower bits of every pixel in the unnecessary regions, thereby permitting relative uplifting of high-frequency component in the regions necessary for monitoring purpose and also recording in high-definition image quality. Since the regions unnecessary for monitoring are recorded with high compression, it becomes possible to carry out long-hour recording.

### CLAIM OF PRIORITY

The present application claims priority from Japanese application serial no. JP 2006-234893, filed on Aug. 31, 2006, the content of which is hereby incorporated by reference into this application.

### BACKGROUND OF THE INVENTION

1. Field of the Invention

This invention relates to a graphic recording apparatus.

2. Description of the Related Art

One example of the background art in the technical field of the present application is Japanese Unexamined Patent Application Publication (JP-A) No. 2006-180200. The object of the invention covered in this application is described as “permitting monitoring in high-definition images even when a monitored site is in a remote place.” Further, a means to achieve the above object is described as “comprising a parameter recorder 60 which stores image-encoding parameters predetermined for each preset position of the monitoring camera, a command analyzer 50 which analyzes commands of camera movements and decides whether or not the monitoring camera should monitor in each of the above preset positions, and an encoder 20 which, in case the command analyzer 50 decides for the monitoring camera to do monitoring in any preset positions, encodes the monitoring images transmitted from the monitoring camera by using the image-encoding parameters corresponding to the preset positions stored in the parameter recorder 60; whereby the parameters to the encoder 20 set up for each preset camera position are optimized making it possible to obtain high-definition images even if the monitored site is in a remote place.”

Another example of the background art is JP-A-2006-94419. The invention in this application is described as having its object of “obtaining an image signal processing apparatus which can enhance image quality by applying preferred corrective processing to the image in each of divided regions,” and further described as having the means of achieving the above object that the image data is first divided into pre-determined regions, secondly that the correlation function between the spatial frequency characteristic of the image data in the divided regions and the spatial frequency characteristic according to human visual characteristic is calculated, also that edge feature extraction processing is made of the image data in a divided region to get the output of edge values therein and to identify which of edge part, flat part, or texture part any particular image data in a divided region is expressive of, and finally that the parameters for peripheral feature corrective processing and noise reduction processing are thus determined on the basis of the correlation function calculated as above, the edge values outputted, and the identified results, so as to carry out processing of peripheral feature correction and noise reduction.”

As for compression technique for the image to be recorded by the graphic recording apparatus, there is available, for example, JPEG (Joint Photographic Experts Group) 2000. The book titled “Easy-to-understand JPEG 2000 Technique” (coauthored by Sadayasu Ono and Junji Suzuki, published by Ohmsha Ltd., 2003; p 60 and pp 137-142) carries this description that “in an application in which encoding can be made of the regions of interest (ROI), any particular region or regions of the image sometimes have a higher importance than other regions, as in the case of images for medical use, for example, which often need to be examined more closely in a lesion than in peripheral areas; thus, with the provision of the above encoding technique, it becomes possible to encode and transmit such important regions within an image called ROI in an image state of higher quality and lower distortion than other background regions.”

### SUMMARY OF THE INVENTION

In recent years, the abovementioned JPEG (Joint Photographic Experts Group) 2000 is being widespread in use as a compression technique suitable for a graphic recording apparatus for monitoring purpose.

Another compression technique such as MPEG (Moving Picture Experts Group) utilizing inter-frame difference as compression element is not much in use, because MPEG is not suitable for a graphic recording apparatus for monitoring, for which purpose recording of image is often made intermittently, and also because MPEG is used at a higher compression ratio than JPEG, a technique generally used for such as digital cameras.

As described above, JPEG2000 covers a technique called “ROI (Region of Interest)” which allocates a large amount of code to a specific region of the image to ensure optimal freshness of image quality in that region. By the use of the ROI, it is possible to improve image quality in only the particular region where special monitoring attention is wanted in the entire image plane.

General state of monitoring is explained in reference to FIG. 2 and FIG. 3. FIG. 2 shows the way in which a camera is installed, and FIG. 3 shows a photographic image taken by the monitoring camera.

The graphic recording apparatus for monitoring employs a monitoring camera as a means of inputting image to the apparatus. The monitoring camera is installed on the ceiling as shown in FIG. 2 in most cases, but owing to limitations in installing position of the camera and field angle of the lens, it often occurs that the ceiling, pillars, or any other things not needed for monitoring purpose may be caught together in the view unintentionally. As shown in FIG. 3, the ceiling portion in the upper part and the wall portion on the left side are regarded the regions unnecessary for the monitoring image. Hereafter, the regions necessary for monitoring are designated as the regions of interest, and the regions unnecessary for monitoring are designated as the regions of noninterest.

If a high level of data volume is compressed just in order to obtain a sufficient image quality in the regions of interest, data volume in the regions of noninterest will also become a high level, consuming wasteful data volume only to fail in securing sufficient recording time. On the contrary, if a low level of data volume is set just to match with the regions of noninterest, it will be difficult to obtain a sufficient image quality in the regions of interest.

Generally speaking, the capacity of recording media of a graphic recording apparatus is fixed. If recording time is prolonged, image quality will have to be sacrificed, while if image quality is enhanced, recording time will have to be shortened. In a graphic recording apparatus for monitoring, recording time is the item of higher priority as compared with image quality (for example, image needs to be stored for at least a week), often leading to the consequence that image quality is compelled to be sacrificed to further extent despite that the image quality in the regions of interest is not quite up to a satisfactory level.

Under the above circumstances in which a graphic recording apparatus for monitoring is placed, any compression technique which can compress the regions of interest and the regions of noninterest at respectively different levels of data volume will be very effective and useful.

As explained above, JPEG2000 covers a technique called “ROI (Region of Interest)” which allocates a large amount of code to a specific region of the image to ensure optimal freshness of image quality in that region. However, the use of ROI technique requires addition of corresponding circuit which is rather complex. A large amount of calculation involved in the use of ROI inevitably causes the compression circuit to get enlarged in scale, ending up in the problem that the cost of the graphic recording apparatus itself is inevitably pushed up.

The patent document 1 refers to the coding parameters which are preset in the parameter storage, but does not go as far as to include the concept that a large volume of data is allocated to the region of interest to enhance the image quality in that region. It is also disclosed in the above document that cutoff frequency is changed region by region as divided in an image, which, however, is aimed merely at noise reduction.

Further, the patent document 2 discloses preferred image corrective processing to be applied to a divided region of an image. However, this processing means an image corrective processing for the purpose of peripheral feature correction and noise reduction, but the disclosure does not go as far as to include the concept that a large volume of data is allocated to the region of interest to enhance the image quality in that region.

The present invention has the object of providing a graphical recording apparatus which can realize enhanced image quality in the regions of interest of an image plane.

An aspect of the present invention to attain the above object may be outlined as follows. In relation to the image signal, the relevant data are converted so as to relatively raise the frequency component of the pixels included in the predetermined regions in an image plane by decreasing the frequency component of the pixels included in the regions other than the above predetermined regions in the image plane; and in relation to the image signal after the above conversion of data, increased data volume is allocated to the above predetermined regions where the frequency component of the pixels has been relatively raised, realizing low compression ratio, while decreased data volume is allocated to the regions other than the above predetermined regions where the frequency component of the pixels has been reduced, realizing high compression ratio; thereby, the data volume as a whole being compressed to a predetermined level.

The present invention is as described in the scope of claims.

According to the present invention, it is possible to record the regions of interest in the image plane in a high-definition image quality. Any other problems, configuration, and effect of the invention than described above will be clarified through the detailed description of preferred embodiments hereinbelow.

### BRIEF DESCRIPTION OF THE DRAWINGS

These and other features, objects and advantages of the present invention will become more apparent from the following description when taken in conjunction with the accompanying drawings wherein:

FIG. 1 is a conceptual diagram explaining overall function of a graphic recording apparatus according to an embodiment of the present invention;

FIG. 2 shows how to install a monitoring camera;

FIG. 3 shows an example of image caught by a monitoring camera;

FIG. 4 shows an example as to how the regions of interest are determined in a graphic recording apparatus according to an embodiment of the present invention;

FIG. 5 is an example of image plane created by the digital picture signal B in a graphic recording apparatus according to an embodiment of the present invention;

FIG. 6 is an example of image plane created by the digital picture signal C in a graphic recording apparatus according to an embodiment of the present invention;

FIG. 7 is an example of picture (characters) inputted to the compression circuit 22 in a graphic recording apparatus according to an embodiment of the present invention; and

FIG. 8 is an example of picture (characters) outputted from the compression circuit 22 in a graphic recording apparatus according to an embodiment of the present invention.

### DETAILED DESCRIPTION OF THE PREFERRED EMBODIMENTS

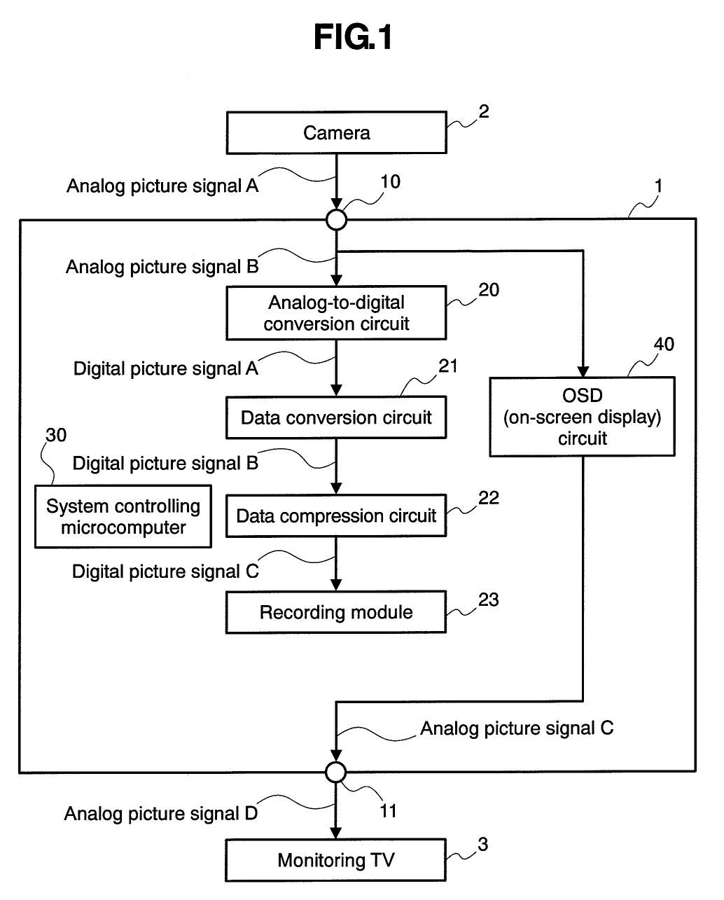

Hereinbelow, a graphic recording apparatus according to an embodiment of the present invention is explained in reference to FIG. 1 to FIG. 6.

### Embodiment 1

With reference to FIG. 1 in the first place, explanation is made of configuration and overall function of a monitoring system using a graphic recording apparatus according to an embodiment of the present invention. FIG. 1 is a conceptual diagram intended to explain overall function of a graphic recording apparatus according to an embodiment of the present invention.

Numbered 1 is a graphic recording apparatus. 2 is a monitoring camera to be connected on the outside which receives the photographic image of an object of shooting, converts the image into analog signals, and outputs the analog picture signal A. 10 is an input terminal used to input the analog picture signal A outputted from the camera 2 to the graphic recording apparatus. 20 is an AD (analog-to-digital) conversion circuit to convert the analog picture signal B into values of eight bits (0-255) for every color of red (R), green (G), and blue (B) to output the digital picture signal A.

21 is a data conversion circuit, which has the function of setting the mask zero to the data of the digital picture signal A by the preset number of bits from the lower bit to higher for each pixel and each color according to the level preset for each region and outputs the digital picture signal B as a result of the above data conversion. 22 is a data compression circuit to compress the digital picture signal B and to output the digital picture signal C. In the present embodiment, JPEG2000 is adopted as the compression technique for the compression circuit. 23 is a recording module to record the digital picture signal C, and in this embodiment, a hard disc (to be called as “HDD” hereinafter) is used for the module. The system control microcomputer 30 is a microcomputer to control the overall operation of the graphic recording apparatus 1. This microcomputer 30 receives operational instructions of any operator from an input key (not shown in the drawing) and, corresponding to such operational instructions, controls each circuit of the graphic recording apparatus 1. The OSD (on-screen display) circuit 40 makes the analog picture signal B overlapped with characters etc., and outputs the analog picture signal C. The OSD circuit 40 also displays setting screen on which setting is made of various conditions of the graphic recording apparatus. The output terminal 11 outputs the analog picture signal D. The monitoring TV 3 is connected on the outside and, receiving the analog picture signal D, displays it on the screen.

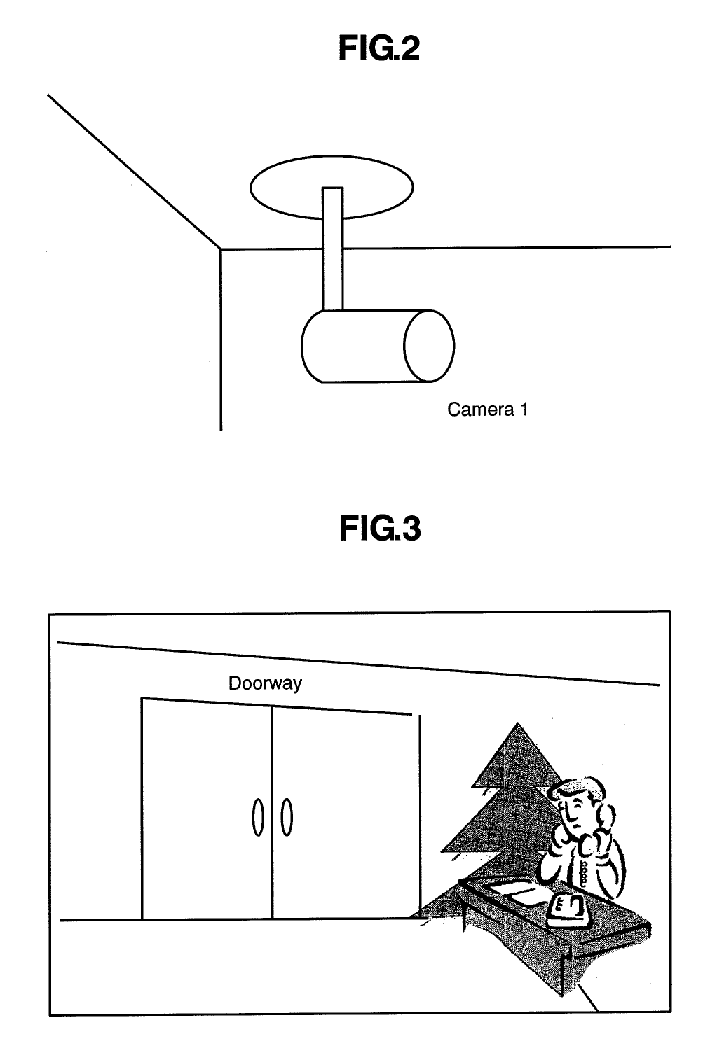

In the next place, the way how to conduct monitoring is explained in reference to FIG. 2 and FIG. 3. FIG. 2 shows how to install a monitoring camera, and FIG. 3 shows an example of image caught by the monitoring camera.

As shown in FIG. 2, the monitoring camera 1 is often fixed on the ceiling, etc., but with being much restricted in respect of installing location or shooting angle. For this reason, places not required to be monitored often appear in the picture. Taking FIG. 3 for example, the ceiling portion on the upper part of the picture, the wall portion on the left side, and the floor portion down below are regarded the regions unnecessary for monitoring purpose (regions of noninterest). On the contrary, the doorway in the center of the picture and the portion a man is sitting are regarded the regions necessary for monitoring purpose (regions of interest).

In the present embodiment, the regions of interest and the regions of noninterest are made available in total four levels, each level having a corresponding mask-setting.

Level 1 means a high-definition image with a higher ratio of high-frequency component, created by not masking lower bits (as is without masking) in the data conversion circuit.

Level 2 produces an image in which high-frequency component is less than Level-1 image, by masking the lower two bits of the color data to zero in the data conversion circuit.

Level 3 produces an image in which high-frequency component is less than Level-2 image, by masking the lower four bits of the color data to zero in the data conversion circuit.

Level 4 produces an image in which high-frequency component is less than Level-3 image, by masking the lower six bits of the color data to zero in the data conversion circuit.

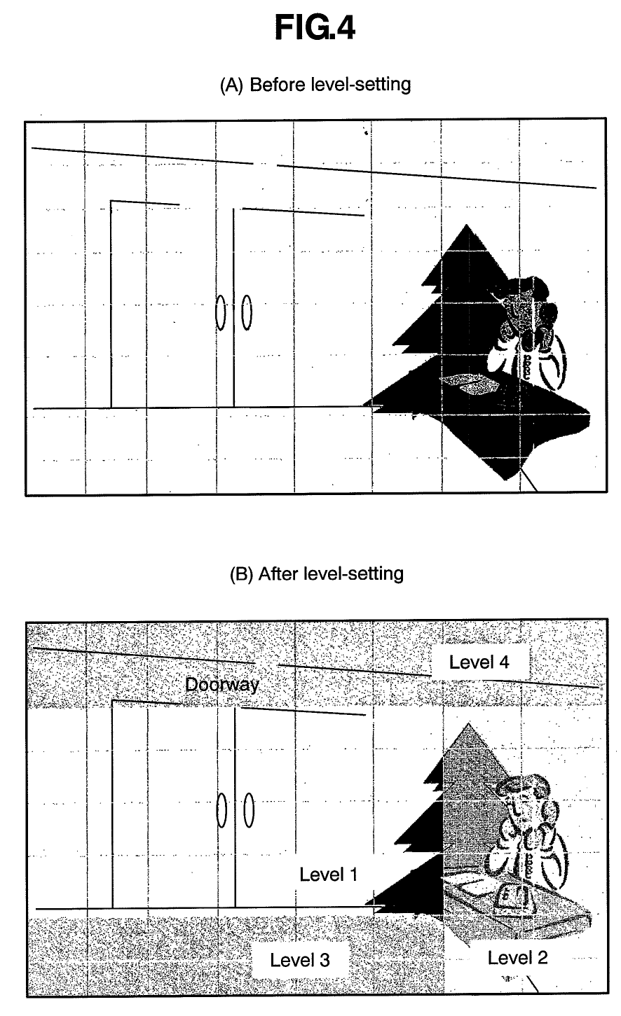

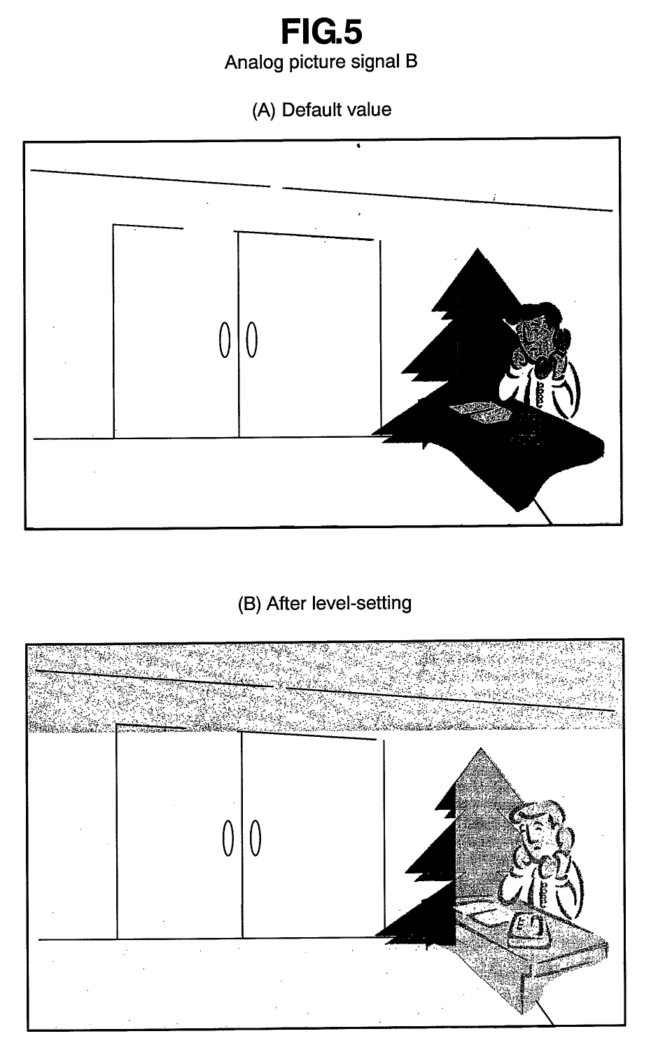

Now, in reference to FIG. 4, the function of masking in each region of image is explained as follows. FIG. 4 shows an example as to how the regions of interest are determined in a graphic recording apparatus according to an embodiment of the present invention. FIG. 4 (A) is the image plane before levels are determined, and FIG. 4 (B) is the image plane after levels are determined. In the present embodiment, it is so arranged that the whole image plane may be divided by 8×8 into 64 regions, for each of which a level may be determined as desired.

As FIG. 4 (A) indicates, the image plane before level-setting is set as Level 1 for all the regions. If level-setting is made here, the image plane turns into one after level-setting as indicated by FIG. 4 (B).

In FIG. 4 (B), the region covering the doorway is the most important region of interest and, therefore, this region is set as Level 1 so as to obtain a high-definition image quality. The portion where a man is sitting is set as Level 2. The ceiling portion and the wall portion on the left side are forming the most unnecessary regions as the regions of noninterest and, therefore, these regions are set as Level 4 so as to have an image of subdued quality. The remaining floor portion is set at Level 3.

This level setting is directed from the system control microcomputer 30 to the data conversion circuit 21.

In the next place, explanation is made of the functions of the data conversion circuit 21 and the data compression circuit 22 in case levels are set for respective regions in the way as abovementioned.

The data compression circuit 22 is designed to create the digital picture signal C compressed to the same pre-determined data volume no matter whatever content of image (whether jet-black, image having different colors for every pixel, or image as illustrated in FIG. 3) may be inputted, a feature necessary for a graphical recording apparatus for monitoring purpose for which fluctuation in recording time is most undesirable. The data compression circuit 22 is also configured so that the region or regions of an image which have a higher ratio of frequency component may be encoded with higher priority. Suppose, for example, that a particular part of an image is high in frequency component, and this entails that a larger amount of data volume is allocated to that part, resulting in low compression ratio, hence an image with a high-definition quality. On the contrary, if the image is composed of even frequency component all over the image, that image will have roughly the same compression ratio on all the regions.

In the present invention, the data conversion circuit 21 is placed before the data compression circuit 22 in order to make good use of these features mentioned above. This is intended to reduce the high-frequency component in the image's region or regions of noninterest, but to relatively raise the frequency component in the region or regions of interest and increase the data volume in the same regions.

The data conversion circuit 21 is designed to mask the lower bits for every pixel, the effect of which is explained here. The AD conversion circuit 20 is to convert the inputted analog picture signal B into the values of 8 bits (0-255) for every color of red (R), green (G), and blue (B) and then to output. If the pixel A and the pixel B, both adjoining with each other, are set at Level 3 (lower four bits are to be masked to zero), the output from the data conversion circuit 21 will be limited to the multiples of 16 (0, 16, 32, 48, 64, . . . ) which are decided by the upper 4 bits, other values being omitted. For example, if the inputted 8-bit value of the pixel A is 56, it turns out to be 48 (56 in decimal number is expressed as [00111000] in binary number; when the lower four bits of this binary number are masked, obtained will be [00110000] which is equal to 48 in decimal number). If the 8-bit number of the pixel B is equal to 63 in decimal number, it likewise turns out after masking to be 48 in decimal number. As a result, the pixel A and the pixel B become equal to each other in 8-bit value, and are to be averaged so as to cut high-frequency component off the image.

As mentioned above, the data conversion circuit 21 applies masks as preset to the lower bits of the inputted digital picture signal A for every pixel. The effect of masking applied to the lower bits by the data conversion circuit 21 of the graphical recording apparatus according to an embodiment of the present invention is explained here with reference to FIG. 5 to FIG. 8.

FIG. 5 shows an example of image plane of the digital picture signal B outputted from the data conversion circuit 21 of the graphical recording apparatus 21 according to an embodiment of the present invention. (The inputted image is the same as the one in FIG. 3) FIG. 5 (A) is the image plane which remains at Level 1 over all regions, and FIG. 5 (B) is the image plane after masking has been applied in accordance with the level-setting shown in FIG. 4 (B). From the image plane in FIG. 5 (B), it is obvious that the details have disappeared in the ceiling portion, the wall portion on the left, and the floor portion, or stated another way, in the regions of noninterest where levels were set as Level 4 and Level 3. Additionally, the image quality in the region of interest, namely the doorway portion, is the same in FIG. 5 (A) and FIG. 5 (B)

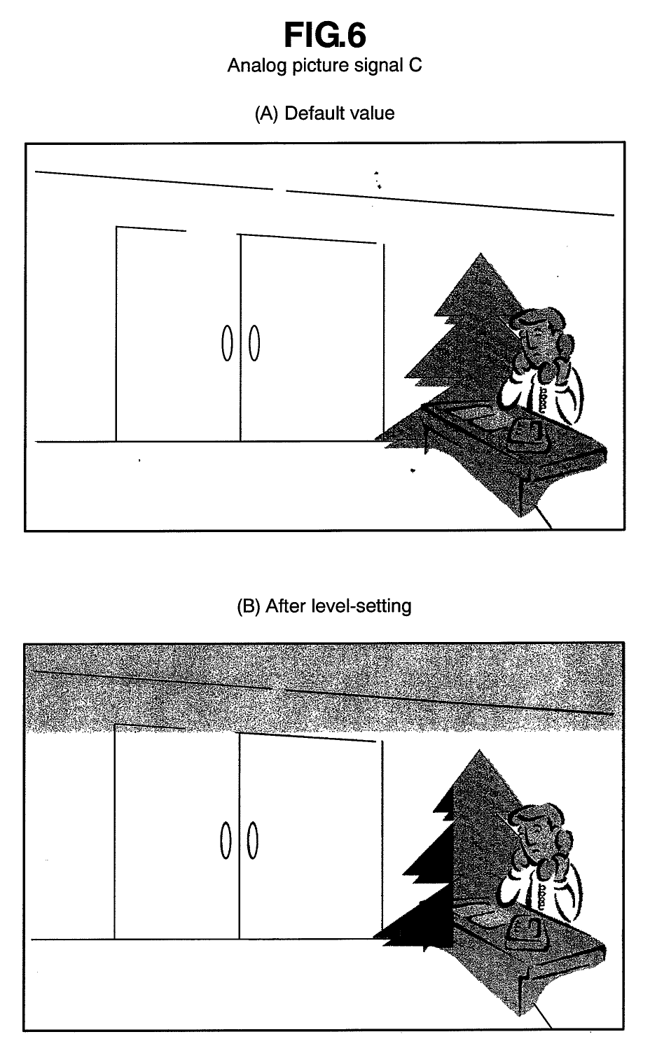

FIG. 6 is an example of image plane created by the digital picture signal C outputted from the data compression circuit 22 of the graphic recording apparatus according to an embodiment of the present invention. FIG. 6 (A) shows the image outputted after compression when the image according to FIG. 5 (A) held at level 1 over all regions was inputted, and FIG. 6 (B) shows the image outputted after compression when the image in FIG. 5 (B) was inputted. In case of FIG. 6 (A), the frequency component of the image is even over all regions, resulting in a high compression ratio when compression is effected to a predetermined data volume and, hence, deteriorated image quality over all regions including the regions of interest. In contrast to the above, the image in FIG. 6 (B) keeps high-frequency component in the regions of interest as it is, while decreasing high-frequency component in the regions of noninterest; thereby permitting the regions of interest with high frequency component to be encoded preferentially, and ensuring a high image quality for the regions of interest, the important regions for the purpose of monitoring. Obviously, the image quality in FIG. 6 (B) is much uplifted than FIG. 6 (A). By masking the lower bits in the regions of noninterest and thereby decreasing high-frequency component in the abovementioned manner, it becomes possible to preferentially encode the regions of interest where frequency component is high and to record the regions of interest out of the overall image plane in high-definition image quality as well as at low cost.

### Embodiment 2

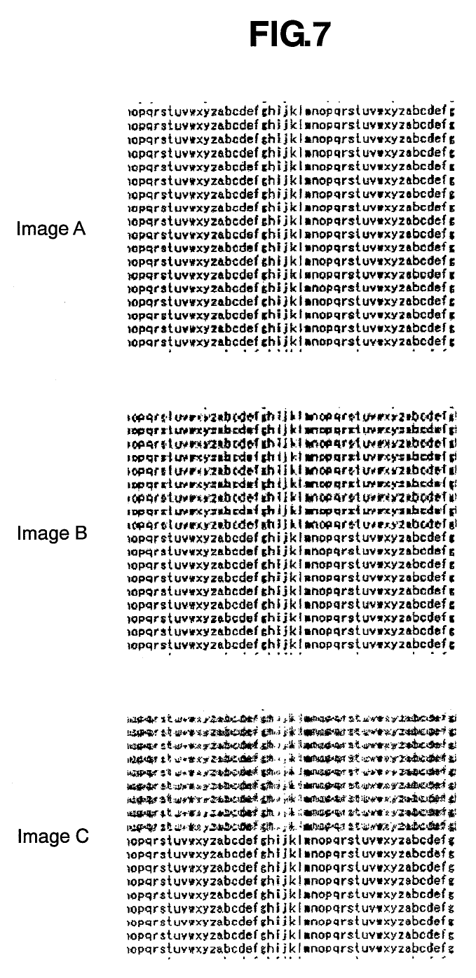

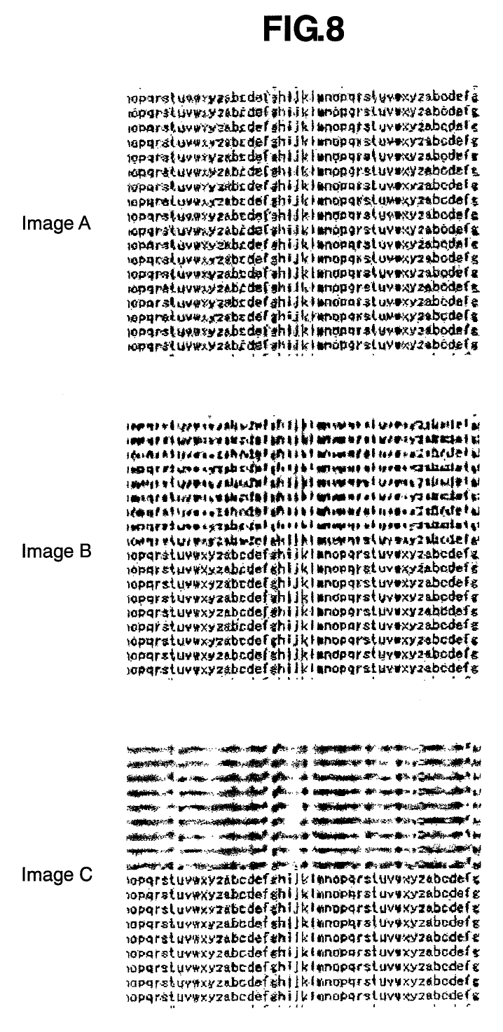

Explanation is made of a second embodiment of the graphic recording apparatus according to the present invention. The difference between the embodiment 2 and the embodiment 1 lies in the data conversion system. Examples of another images actually outputted from the data compression circuit 22 are explained in reference to FIG. 7 and FIG. 8.

FIG. 7 shows an example of the image (characters) inputted to the data compression circuit 22 of the graphic recording apparatus according to an embodiment of the present invention. Image A is the original image, and Images B and C are the images created by applying data conversion to the upper half of Image A by the data conversion circuit 21; for Image B, mosaic-like averaged state is obtained by taking four (2×2) pixels as a block, and for Image C, Gaussian function is used to obtain averaged state. These images in FIG. 7, when compressed by the data compression circuit 22, turn out to be the images in FIG. 8.

FIG. 8 shows an example of the image (characters) outputted from the data compression circuit 22 of the graphic recording apparatus according to an embodiment of the present invention. Images A to C in FIG. 8 are the results obtainable when Images A to C in FIG. 7 are inputted. Images B and C will be found with the characters in the lower half part more readable than Image A to which no data conversion is applied at all.

Generally a graphic recording apparatus is provided with a function of reproducing a recorded image, but such a function is well-known and will not need any explanation here.

The present invention is not limited to the abovementioned embodiments but is inclusive of many variations thereof. For example, the abovementioned embodiments are described in detail in order to make the present invention easily understandable, but the present invention should not be limited to what is configured fully in the way described above. It is possible to replace a part of configuration of an embodiment with a configuration of another embodiment and also to add a configuration of another embodiment to a certain configuration of an embodiment.

In summary, the present invention enables high-definition recording of the regions of interest in an image plane.

While we have shown and described several embodiments in accordance with our invention, it should be understood that disclosed embodiments are susceptible to changes and modifications without departing from the scope of the invention. Therefore, we do not intend to be bound by the details shown and described herein but intend to cover all such changes and modifications as fall within the ambit of the appended claims.

What is claimed is:

1. A graphic recording apparatus, comprising:
a data conversion module which, in relation to an image signal, performs data conversion by decreasing the frequency component of the pixels included in the regions other than predetermined regions composing a part of the image plane and thereby relatively uplifting the frequency component of the pixels included in the predetermined regions;
a data compression module which, in relation to the image signal after data conversion performed by said data conversion module, allocates an increased data volume to realize low compression ratio, to the predetermined regions where the frequency component of pixels has been relatively uplifted, and allocates a decreased data volume to realize high compression ratio, to the regions other than said predetermined regions where the frequency component of pixels has been brought down; thereby, the data volume for said whole image plane being compressed to a predetermined level; and
a recording module to record in a recording media the image signal compressed by said data compression module.

2. A graphic recording apparatus, comprising:
a data conversion module which, in relation to an image signal, performs data conversion by bringing down frequency component of the pixels included in the regions other than the predetermined regions composing a part of the image plane;
a data compression module which, in relation to the image signal after data conversion performed by said data conversion module, allocates an increased data volume to the regions where frequency component is high, thereby, the data volume for the whole image plane being compressed to a predetermined level; and
a recording module to record in a recording media the image signal compressed by said data compression module.

3. A graphic recording apparatus to digitalize an image signal, and compress and record such digitalized image signal, comprising:
an AD conversion circuit configured to digitalize said image signal and output a digital picture signal A,
a data conversion circuit configured to perform data conversion of said digital picture signal A and output a digital picture signal B,
a data compression circuit configured to compress said digital picture signal B and output a digital picture signal C, and
a recording module configured to record said digital picture signal C;
wherein said data conversion circuit performs data conversion in order to decrease frequency component in a part of an image signal, and
wherein frequency component in a predetermined region of an image is decreased by said data conversion circuit.

4. The graphic recording apparatus according to claim 3, to be used for monitoring purpose.

5. The graphic recording apparatus according to claim 3, wherein the data conversion by said data conversion circuit is performed by masking lower bits of each pixel of said digital picture signal A.

6. The graphic recording apparatus according to claim 3, wherein the data conversion by said data conversion circuit is intended to take the average between adjoining pixels of the digital picture signal A.

7. The graphic recording apparatus according to claim 3, wherein JPEG (Joint Photographic Experts Group) 2000 is used as the image compression technique of said data compression circuit.

8. A graphic recording apparatus, comprising:
a data conversion module which performs data conversion so as to relatively uplift frequency component of pixels included in predetermined regions composing a part of an image plane, in comparison with the frequency component of the pixels included in the regions other than said predetermined regions;
a data compression module which, in relation to the picture signal having been through data conversion by said data conversion module, allocates increased data volume to the regions where frequency component is higher, thereby compressing the data volume for the whole image plane to a predetermined level; and
a recording module to record in a recording media the image signal compressed by said data compression module.
